(19) United States
(12) Patent Application Publication
(10) Pub. No.: US 2011/0147376 A1
(43) Pub. Date: Jun. 23, 2011

(54) COOKING DEVICE

(76) Inventors: Shinya Ueda, Osaka (JP); Hideo Shimoda, Osaka (JP); Takashi Utsumi, Osaka (JP)

(21) Appl. No.: 13/059,148

(22) PCT Filed: Aug. 28, 2009
(86) PCT No.: PCT/JP2009/065058

§ 371 Date: Feb. 15, 2011

(30) Foreign Application Priority Data
Aug. 29, 2008 (JP) 2008-222582

(51) Int. Cl. H05B 6/64

(52) U.S. Cl. 219/682

(57) ABSTRACT

A cooking device comprises: a heating chamber (11) equipped with a placement section (11d), the placement section (11d) being adapted such that a tray (17) is placed thereon, the tray (17) having a placement net (17a) for placing thereon an object to be cooked; a vapor generating device (1) for generating vapor and supplying the vapor between the placement net (17a) and the tray (17); a circulation duct (12) having a circulation fan (16) and circulating gas in the heating chamber (11); a convection heater (15) provided in the circulation duct (12); a gas supply opening (38) provided below the tray (17); a gas discharge opening (41) provided below the tray (17); and a magnetron (33) for supplying a microwave to the heating chamber (11). The cooking device is provided with a range mode for performing cooking by a microwave, a grill mode for performing cooking by superheated vapor by driving the circulation fan (16) and the convection heater (15), and a steaming mode for performing cooking by saturated vapor with the circulation fan (16) and the convection heater (15) stopped.

### TECHNICAL FIELD

The present invention relates to a cooking device that performs cooking by supplying steam and microwaves to a heating chamber.

### BACKGROUND ART

Patent Document 1 discloses a conventional cooking device that performs cooking by supplying microwaves. This cooking device includes a heating chamber whose front surface is opened/closed by a door and that houses an object to be cooked. A magnetron that supplies microwaves to the heating chamber is disposed on one lateral side of the heating chamber, and a blower fan is disposed on a back side of the magnetron.

An air supply port for supplying outside air into the heating chamber by the blower fan is open on one side wall of the heating chamber. An air discharge port for discharging gas in the heating chamber is open at an upper portion of the other side wall of the heating chamber. The air discharge port is open to the atmosphere via a passage, and a humidity sensor is disposed in the passage.

When cooking is started, the blower fan and the magnetron are driven so that cooking using microwaves is performed. By the driving of the blower fan, outside air is supplied into the heating chamber through the air supply port and is discharged through the air discharge port. The humidity of exhaust air containing steam generated from an object to be cooked is detected by the humidity sensor, and based on the result thereof, it is determined whether it is the time to complete the cooking.

There is also known a cooking device provided with, in addition to a magnetron as described above, a steam generator that generates steam. When cooking using steam is performed, a blower fan and the magnetron are deactivated, and steam is supplied into a heating chamber by the steam generator. Thus, cooking using saturated steam is performed. Furthermore, in a case where a heater that heats steam in the heating chamber is provided, cooking using superheated steam can be performed.

### LIST OF CITATIONS

### Patent Literature

Patent Document 1: JP-A-H 7-151334 (Pages 3 to 4, FIG. 5)

### SUMMARY OF THE INVENTION

### Technical Problem

In the cooking device disclosed in Patent Document 1 mentioned above, however, since steam generated from an object to be cooked flows upward, the air discharge port is provided at an upper portion of the heating chamber. Because of this, in a case where a steam generator is provided and cooking using steam thus is performed, steam flows out through the air supply port and the air discharge port. This has led to a problem that steam generated by the steam generator is not fully used for cooking, so that heating efficiency is deteriorated.

It is an object of the present invention to provide a cooking device that can provide improved heating efficiency.

### Solution to the Problem

In order to achieve the above-described object, the present invention is characterized by including: a heating chamber in which a seating base is provided on a wall surface of the heating chamber so that a tray is seated on the seating base, and a rack for placing an object to be cooked thereon is disposed on the tray; a steam generator that generates steam and supplies the steam between the rack and the tray; a circulation duct that includes inside a circulation fan so as to circulate gas in the heating chamber; a convection heater that is disposed in the circulation duct; an air supply port through which outside air is taken into the heating chamber and that is disposed below the level of the tray; an air discharge port through which gas in the heating chamber is discharged to the atmosphere and that is disposed below the level of the tray; and a magnetron that supplies microwaves to the heating chamber and is deactivated based on a state of exhaust air at the air discharge port. The cooking device is operated in: a microwave mode in which cooking using microwaves is performed; a grill mode in which the circulation fan and the convection heater are driven so that cooking using superheated steam is performed; and a steaming mode in which the circulation fan and the convection heater are deactivated so that cooking using saturated steam is performed.

According to this configuration, an object to be cooked is placed on the rack on the tray, and the tray is seated on the seating bases. When cooking in the microwave mode is started, the magnetron is driven to supply microwaves into the heating chamber, and the cooking is performed using the microwaves. Outside air is supplied into the heating chamber through the air supply port and is discharged through the air discharge port. In this configuration, the humidity or the like of exhaust air containing steam generated from the object to be cooked is detected, and at the time the humidity or the like of the exhaust air attains a predetermined value, the cooking is completed.

When cooking in the grill mode is started, the steam generator, the circulation fan, and the convection heater are driven. In the heating chamber, steam from the steam generator is supplied between the tray and the rack. The steam in the heating chamber circulates via the circulation duct by the circulation fan and is heated by the convection heater in the circulation duct. By this configuration, an object to be cooked is cooked using superheated steam having a predetermined temperature.

When cooking in the steaming mode is started, the steam generator is driven, and the circulation fan and the convection heater are deactivated. In the heating chamber, steam from the steam generator is supplied between the tray and the rack. The steam is hindered from flowing downward by the tray, and it therefore flows upward and surrounds an object to be cooked. By this configuration, the object to be cooked is cooked by steaming using saturated steam.

Furthermore, the present invention is characterized in that, in the cooking device having the above-described configuration, the air supply port is disposed below the level of the air discharge port. According to this configuration, steam having a decreased temperature as a result of having contacted an object to be cooked flows downward through between the tray and the wall surfaces of the heating chamber and then is discharged through the air discharge port above the level of the air supply port.

Furthermore, the present invention is characterized in that, in the cooking device having the above-described configuration, the air supply port is disposed at a front portion of the heating chamber, and the air discharge port is disposed at a back portion of the heating chamber. According to this configuration, the air supply port and the air discharge port are disposed away from each other, and thus a shortcut phenomenon of airflow is prevented.

### Advantageous Effects of the Invention

According to the present invention, the air discharge port and the air supply port are disposed below the level of the tray, with steam supplied between the tray and the rack, and when the steaming mode is performed, the circulation fan and the convection heater are deactivated. By this configuration, the steam is blocked by the tray and fills an upper side of the tray, and thus cooking by steaming is performed. The steam having a decreased temperature as a result of having contacted an object to be cooked flows downward and then flows out through the air discharge port and the air supply port on a lower side. This can reduce the outflow of high-temperature steam supplied from the steam generator, and thus can improve heating efficiency.

### BRIEF DESCRIPTION OF DRAWINGS

FIG. 1 A right side view showing a cooking device according to an embodiment of the present invention.

FIG. 2 A front view showing the cooking device according to the embodiment of the present invention.

FIG. 3 A cross-sectional top view showing the cooking device according to the embodiment of the present invention.

FIG. 4 A cross-sectional front view showing a steam generator of the cooking device according to the embodiment of the present invention.

FIG. 5 A cross-sectional view taken on line A-A of FIG. 4.

### DESCRIPTION OF EMBODIMENT

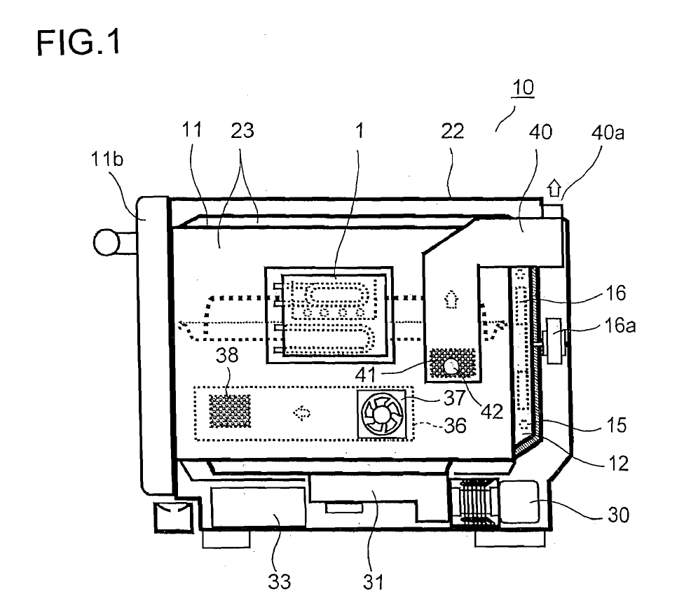

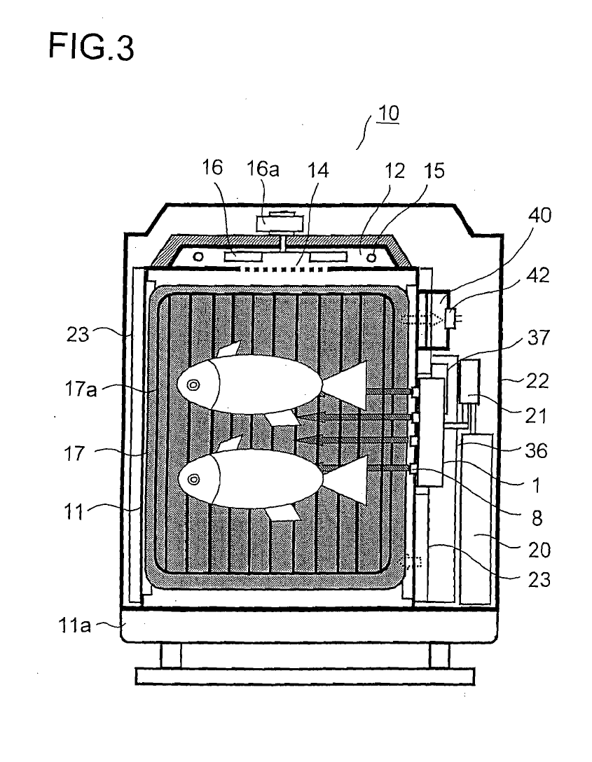

The following describes an embodiment of the present invention with reference to the appended drawings. FIGS. 1, 2, and 3 are a right side view, a front view, and a cross-sectional top view showing an inner portion of a cooking device according to one embodiment. A cooking device 10 has, in a main body casing 22, a heating chamber 11 that has substantially a rectangular parallelepiped shape and houses an object to be cooked. The side walls and ceiling wall of the heating chamber 11 are covered with a heat shield plate 23 so as to be thermally shielded, and the front surface of the heating chamber 11 is opened/closed by a door 11b.

A temperature sensor 11c that detects the room temperature of the heating chamber 11 is provided on the top surface of the heating chamber 11. Based on a temperature detected by the temperature sensor 11c, an after-mentioned convection heater 15 is controlled. Seating bases 11d are provided in a standing manner on the side walls in the heating chamber 11. A tray 17 is seated on the seating bases 11d, and a rack 17a for placing an object to be cooked W thereon is disposed on the tray 17. The tray 17 is formed in the shape of a flat plate without openings. An upper portion and a lower portion of the heating chamber 11 are blocked from each other by the tray 17 and communicate with each other via clearance between the tray 17 and the peripheral walls of the heating chamber 11.

An outside air inflow duct 34 is formed between the heating chamber 11 and the main body casing 22 so as to extend on a lower side and a right lateral side of the heating chamber 11. The outside air inflow duct 34 has a suction port 34a that is open on the bottom surface of the main body casing 22. In a lower portion of the outside air inflow duct 34, a cooling fan 35, an electrical equipment portion 33, and a magnetron 30 are disposed. In a side portion of the outside air inflow duct 34, an air supply duct 36 having an air supply fan 37 is disposed. The air supply duct 36 has an air supply port 38 that is open at a front portion of a side wall 11a that is one of the side walls of the heating chamber 11.

The electrical equipment portion 33 has driving circuits that respectively drive parts of the cooking device 10 and a control portion (not shown) that controls the driving circuits, and a multitude of heat generating elements are mounted in the electrical equipment portion 33. The magnetron 30 supplies microwaves into the heating chamber 11 via a waveguide 31. An antenna 32 that is rotated by an antenna motor 32a is disposed in the waveguide 31, and thus microwaves are supplied to the heating chamber 11 in a uniform manner.

The cooling fan 35 takes outside air into the outside air inflow duct 34 via the suction port 34a and thereby cools the electrical equipment portion 33 and the magnetron 30, which generate heat. The outside air taken into the outside air inflow duct 34 flows out through an opening (not shown) formed on the back surface or the like of the main body casing 22. Furthermore, by the driving of the air supply fan 37, part of the outside air flows into the air supply duct 36.

In a back portion of the side wall 11a of the heating chamber 11, an air discharge duct 40 is led out via an air discharge port 41. The air discharge duct 40 is formed so as to extend to a back side of the heating chamber 11 and has an open end 40a that is open on the top surface of the main body casing 22. Furthermore, a humidity sensor 42 that detects the humidity of exhaust air at the air discharge port 41 is provided in the air discharge duct 40.

A steam generator 1 that supplies steam to the heating chamber 11 via an ejection port 8 is mounted to an upper portion of the side wall 11a of the heating chamber 11. The ejection port 8 is disposed so as to eject steam between the tray 17 and the rack 17a.

A demountable water supply tank 20 is disposed on a lateral side of the steam generator 1. A water supply pump 21 connected to a water supply port 3 of the steam generator 1 is disposed behind the water supply tank 20. When mounted, the water supply tank 20 is connected to the water supply pump 21 via a fitting (not shown). By the driving of the water supply pump 21, water is supplied from the water supply tank 20 to the steam generator 1 via a water delivery pipe 21a.

A circulation duct 12 is provided behind the heating chamber 11. The circulation duct 12 has an air suction port 14 at a center portion of the back wall of the heating chamber 11 and a plurality of blow-out ports 13 at a portion of the back wall of the heating chamber 11 around the center portion. In the circulation duct 12, a circulation fan 16 and the convection heater 15 are provided. The circulation fan 16 is driven to be rotated by a fan motor 16a. The circulation fan 16 sucks steam in the heating chamber 11 into the circulation duct 12 through the air suction port 14 and blows the steam out through the blow-out ports 13. The convection heater 15 is formed by a ring-shaped sheathed heater and maintains steam flowing through the circulation duct 12 at a predetermined temperature.

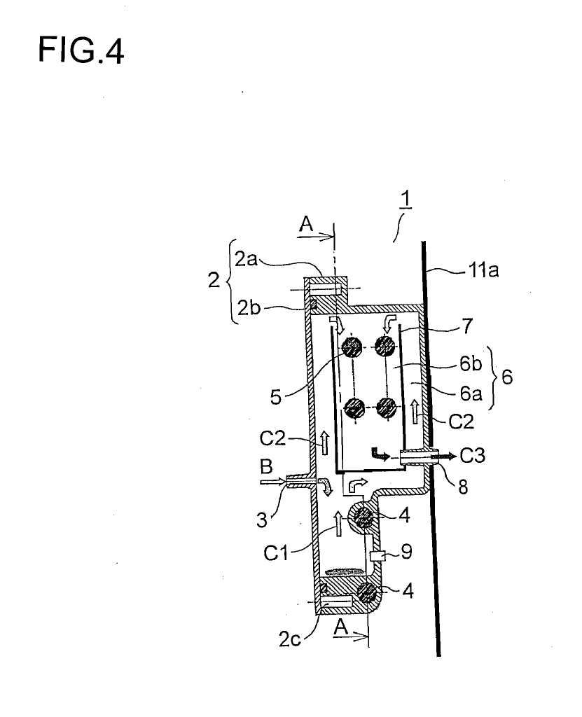

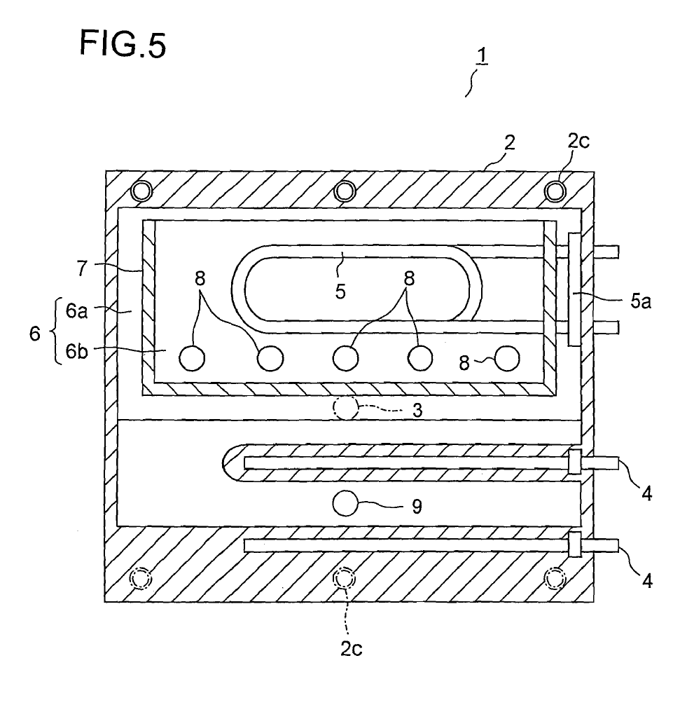

FIG. 4 shows a cross-sectional front view of the steam generator 1. FIG. 5 shows a cross-sectional view taken on line A-A of FIG. 4. The steam generator 1 has a housing 2 made of a metal die casting. In the housing 2, an opening surface of a box-shaped main body portion 2a is closed by a lid portion 2b that is fixed with a screw 2c, so that a cavity is formed in an inner portion of the housing 2. It is preferable that aluminum or an aluminum alloy be used as a material of the main body portion 2a and the lid portion 2b of the housing 2 since they provide good casting performance and have high thermal conductivities.

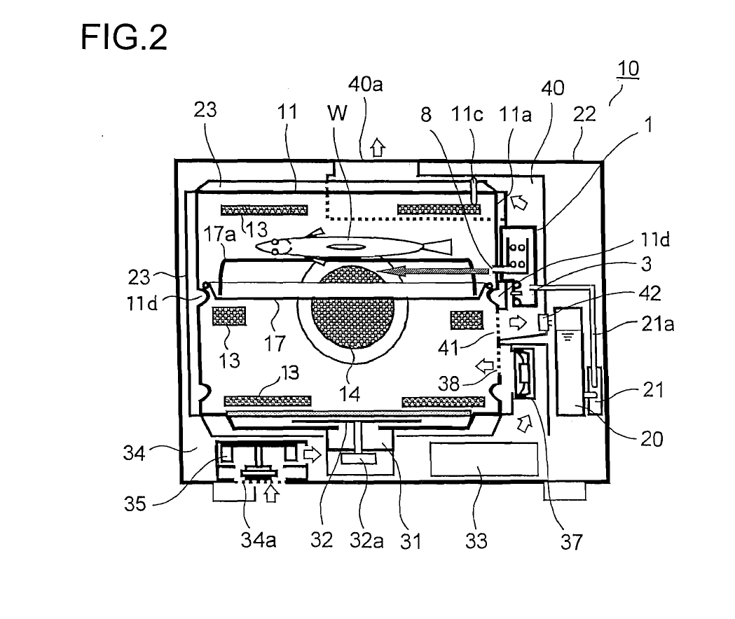

In the lid portion 2b of the housing 2, the water supply port 3 connected to the water supply pump 21 (See FIG. 2) is open at a center portion in the vertical direction. In the main body portion 2a, a plurality of the ejection ports 8 are provided so as to face the side wall 11a of the heating chamber 11.

Steam generation heaters 4 made of sheathed heaters are disposed in a lower portion of the housing 2. The steam generation heaters 4 are embedded by molding in the housing 2 and thus are in close contact with the housing 2, so that heat of the steam generation heaters 4 is conducted efficiently to the housing 2. Thus, using heat conducted from the steam generation heaters 4 to the housing 2, water that drips from the water supply port 3 and collects in a bottom portion of the housing 2 is evaporated to form steam.

The ejection ports 8 are formed on a surface protruding with respect to the lower portion of the housing 2, in which the steam generation heaters 4 are embedded. Hence, the lower portion of the housing 2, which is heated to a high temperature by the steam generation heaters 4, is disposed away from the side wall 11a of the heating chamber 11. This enables simplifying the heat-resistant structure of the heating chamber 11.

A temperature sensor 9 is mounted in the vicinity of the steam generation heaters 4. The temperature sensor 9 is embedded in the housing 2 in order to monitor the temperature of the housing 2 and detect the occurrence of no-water burning. The temperature sensor 9 also detects the occurrence of insufficient heating due to, for example, a malfunction of the steam generation heaters 4.

In an upper portion of the housing 2, a steam heat-up heater 5 is disposed that is formed by a sheathed heater formed into a spiral so as to be arranged in plural rows in the lateral direction. The steam heat-up heater 5 is mounted to the housing 2 via a flange portion 5a that is a non-heat generating portion thereof, and a heat generating portion of the steam heat-up heater 5 is disposed at a predetermined distance from the inner walls of the housing 2. Thus, even when the temperature of the steam heat-up heater 5 is increased, the temperature increase of the housing 2 can be suppressed.

A box-shaped partition member 7 whose upper surface is open and that encloses the steam heat-up heater 5 is provided around the steam heat-up heater 5. The ejection ports 8 are each formed in the shape of a cylinder penetrating the partition member 7 and disposed at a lower portion of the bottomed partition member 7. Furthermore, the partition member 7 is partly joined to the housing 2 so as to be supported by the housing 2 and is disposed at a predetermined distance away from the inner walls of the housing 2.

Thus, a steam passage 6 is fanned, along which steam is guided from the lower portion of the housing 2 to the ejection ports 8 by passing through the steam heat-up heater 5. This can prevent a shortcut phenomenon of steam in which steam flows out through the ejection ports 8 directly from the lower portion of the housing 2 without passing through the steam heat-up heater 5, and thus superheated steam can be generated reliably.

Furthermore, since the partition member 7 is away from the inner walls of the housing 2, the housing 2 can be prevented from being overheated. Moreover, steam flows along an outer passage 6a between the housing 2 and the partition member 7 and thus cools the housing 2, so that the housing 2 can be further prevented from being overheated.

The steam passage 6 is composed of the outer passage 6a on an outer side of the partition member 7 and an inner passage 6b on an inner side of the partition member 7. The outer passage 6a and the inner passage 6b communicate with each other at an upper end of the partition member 7, and the ejection ports 8 are provided at a lower portion of a space enclosed by the partition member 7.

The partition member 7 is made of a metal having higher resistance than that of the housing 2 or ceramic. It is preferable that the partition member 7 be made of stainless steel or the like that has excellent corrosion resistance. Furthermore, surfaces of the partition member 7, which are opposed to the steam heat-up heater 5, are formed in dark color by the application of a heat-resistant black coating. Thus, radiant heat of the steam heat-up heater 5 is absorbed by the partition member 7, so that the temperature increase of the housing 2 is suppressed. Also, it made possible to prevent the occurrence of dissimilar metal galvanic corrosion at a joint portion between the partition member 7 and the housing 2.

The cooking device 10 is operated in a plurality of cooking modes composed of a microwave mode, a grill mode, and a steaming mode, from among which a user makes a selection and a thus selected mode is performed. Cooking in the microwave mode is performed using microwaves. Cooking in the grill mode is performed using superheated steam. Cooking in the steaming mode is performed using saturated steam.

When cooking in the microwave mode is started, the magnetron 30 and the antenna motor 32a are driven. Furthermore, the cooling fan 35 and the air supply fan 37 are driven. The magnetron 30 supplies microwaves into the heating chamber 11 via the waveguide 31, and thus the object to be cooked W is heated by the microwaves.

The cooling fan 35 makes outside air flow into the outside air inflow duct 34 through the suction port 34a. The outside air that has flowed into the outside air inflow duct 34 cools the electrical equipment portion 33 and the magnetron 30 and then is discharged to the exterior. Part of the outside air having an increased temperature as a result of having cooled the electrical equipment portion 18 and the magnetron 30 is guided to the air supply duct 36 by the air supply fan 37.

The outside air flowing through the air supply duct 36 is supplied to the heating chamber 11 through the air supply port 38. At this time, since the air supply port 38 is disposed at a front portion of the heating chamber 11, the airflow blown out through the air supply port 38 flows along the door 11b. Thus, using the air having an increased temperature as a result of having cooled the electrical equipment portion 33 and the magnetron 30, condensation on the door 11b can be prevented.

As a consequence of supply of the air through the air supply port 38, air in the heating chamber 11 is discharged through the air discharge port 41 to flow through the air discharge duct 40 and then is emitted to the atmosphere through the open end 40a. The humidity of the air flowing through the air discharge duct 40 is detected by the humidity sensor 42. Under heating by microwaves, steam is generated from the object to be cooked W, and at the time the humidity in the heating chamber 11 attains a predetermined value, upon detection thereof by the humidity sensor 42, it is determined that it is the time to complete the cooking. In this manner, the cooking in the microwave mode is completed.

In place of the humidity sensor 42, a sensor that detects the state of exhaust air, such as a temperature sensor, may be used. In this case, when the sensor detects that a predetermined state of exhaust air has been attained, the microwave mode is completed.

When cooking in the grill mode is performed, the water supply tank 20 storing water is mounted. Then, the object to be cooked W is placed on the rack 17a and cooking is started. Upon starting the cooking, the water supply pump 21 is driven and, subsequently, the steam generation heaters 4 and the steam heat-up heater 5 are driven. As shown by an arrow B (see FIG. 4), the water supply pump 21 supplies water into the housing 2 of the steam generator 1 through the water supply port 3.

The water supplied to the housing 2 collects in the lower portion of the housing 2 and then is evaporated to form steam by the steam generation heaters 4. At this time, the steam generation heaters 4 are set to generate heat at a temperature lower than the softening temperature of the housing 2. Furthermore, since the steam heat-up heater 5 is away from the housing 2 and blocked from the housing 2 by the partition member 7, the steam heat-up heather 5 is set to generate heat at a temperature higher than the softening temperature of the housing 2.

For example, in a case where the housing 2 is made of aluminum or an aluminum alloy, the housing 2 has a softening temperature of about 400° C. In this case, since the steam generation heaters 4 are only required to evaporate water, the steam generation heaters 4 are set to generate heat at about 200° C. Furthermore, since the steam heat-up heater 5 is to generate high-temperature superheated steam, the steam heat-up heater 5 is set to generate heat at about 600° C.

The steam generated in the lower portion of the housing 2 flows upward along the steam passage 6 as shown by an arrow C1 (see FIG. 4) and then flows along the outer passage 6a on the outer side of the partition member 7 as shown by an arrow C2 (see FIG. 4). The steam flowing along the outer passage 6a exchanges heat with the partition member 7 that has absorbed radiant heat of the steam heat-up heater 5. The steam flowing along the outer passage 6a exchanges heat also with the housing 2 to cool the housing 2. In this case, heat exchange fins may be provided on the outer surfaces of the partition member 7 and the inner walls of the housing 2. Such a configuration can improve heat exchange efficiency.

The steam that has flowed from above into an inner portion of the partition member 7 flows downward due to steam pressure and then is guided to the ejection ports 8. At this time, the steam exchanges heat with the inner surfaces of the partition member 7 and the steam heat-up heater 5, and thus the temperature of the steam is further increased. Thus, superheated steam is generated and ejected between the tray 17 and the rack 17a in the heating chamber 11 through the ejection ports 8 as shown by an arrow C3 (see FIG. 4). Heat exchange fins may be provided on the inner surfaces of the partition member 7.

The object to be cooked W on the rack 17a is cooked using the superheated steam supplied into the heating chamber 11. Due to the superheated steam, the internal pressure in the heating chamber 11 is increased to cause the steam to flow out through the air discharge port 41 and the air supply port 38. At this time, since the air discharge port 41 is disposed above the level of the air supply port 38, part of the steam, which flows out through the air supply port 38, is small in amount. This can prevent the main body casing 22 from being filled with steam via the air supply duct 36, and thus can prevent condensation in the main body casing 22.

Furthermore, by the driving of the circulation fan 16, the steam in the heating chamber 11 flows into the circulation duct 12 via the air suction port 14. The steam flowing through the circulation duct 12 is heated by the convection heater 15 and then is blown out into the heating chamber 11 through the blow-out ports 13. The output of the convection heater 15 is changed depending on the temperature detected by the temperature sensor 11c. Thus, the steam in the heating chamber 11 is maintained at a predetermined temperature. After the lapse of a cooking time, the cooking is completed.

When cooking in the steaming mode is started, the water supply tank 20 storing water is mounted. Then, the object to be cooked W is placed on the rack 17a and cooking is started. Upon starting the cooking, the water supply pump 21 is driven and, subsequently, the steam generation heaters 4 are driven. At this time, the steam heat-up heater 5, the circulation fan 16, and the convection heater 15 are deactivated. As shown by the arrow B (see FIG. 4), the water supply pump 21 supplies water into the housing 2 of the steam generator 1 through the water supply port 3.

The water supplied to the housing 2 collects in the lower portion of the housing 2 and then is evaporated to form steam by the steam generation heaters 4. The steam generated in the lower portion of the housing 2 flows along the steam passage 6 and then is ejected through the ejection ports 8 as shown by the arrow C3 (see FIG. 4). Thus, the steam is supplied between the tray 17 and the rack 17a in the heating chamber 11 (see FIG. 2).

The saturated steam with a temperature near 100° C. supplied into the heating chamber 11 is blocked by the tray 17, and with the circulation fan 16 being in a deactivated state, it fills an upper side of the tray 17. Thus, the object to be cooked W on the rack 17a is cooked by steaming, and after the lapse of a cooking time, the cooking is completed.

The steam having a decreased temperature as a result of having contacted the object to be cooked flows downward between the tray 17 and the peripheral walls of the heating chamber 11, and due to an increase in the internal pressure in the heating chamber 11, it flows out through the air discharge port 42 and the air supply port 38. At this time, since the air discharge port 42 is disposed above the level of the air supply port 38, part of the steam, which flows out through the air supply port 38, is small in amount. This can prevent the main body casing 22 from being filled with steam via the air supply duct 36, and thus can prevent condensation in the main body casing 22.

According to the present embodiment, the air discharge port 41 and the air supply port 38 are disposed below the level of the tray 17, with steam supplied between the tray 17 and the rack 17a, and when the steaming mode is performed, the circulation fan 16 and the convection heater 15 are deactivated. By this configuration, the steam is blocked by the tray 17 and fills the upper side of the tray 17, and thus cooking by steaming is performed. The steam having a decreased temperature as a result of having contacted the object to be cooked W flows downward and then flows out through the air discharge port 41 and the air supply port 38 on a lower side. This can reduce the outflow of high-temperature steam supplied from the steam generator 1, and thus can improve heating efficiency.

Furthermore, since the air discharge port 42 is disposed above the level of the air supply port 38, the outflow of steam through the air supply port 38 can be reduced. This can prevent the main body casing 22 from being filled with steam via the air supply duct 36, and thus can prevent condensation in the main body casing 22.

Furthermore, the air supply port 38 is disposed at the front portion of the heating chamber 11, and the air discharge port 41 is disposed at a back portion of the heating chamber 11, and thus the air supply port 38 and the air discharge port 41 are away from each other, so that when the microwave mode is performed, the occurrence of a short-circuit phenomenon can be reduced. Furthermore, airflow blown out through the air supply port 38 flows along the door 11b, and thus condensation on the door 11b can be prevented.

### INDUSTRIAL APPLICABILITY

The present invention can be applied to a cooking device that performs cooking by supplying steam and microwaves to a heating chamber.

### LIST OF REFERENCE SIGNS

1 Steam generator
2 Housing
3 Water supply port
4 Steam generation heater
5 Steam heat-up heater
6 Steam passage
7 Partition member
8 Ejection port
9, 11c Temperature sensor
10 Cooking Device
11 Heating chamber
12 Circulation duct
13 Blow-out port
14 Air suction port
15 Convection heater
16 Circulation fan
20 Water supply tank
21 Water supply pump
22 Main body casing
23 Heat shield plate
30 Magnetron
31 Waveguide
32 Antenna
33 Electrical equipment portion
34 Cooling duct
35 Cooling fan
36 Air supply duct
37 Air supply fan
38 Air supply port
40 Air discharge duct
41 Air discharge port
42 Humidity sensor

1. A cooking device, comprising:
a heating chamber in which a seating base is provided on a wall surface of the heating chamber so that a tray is seated on the seating base, a rack for placing an object to be cooked thereon being disposed on the tray;
a steam generator that generates steam and supplies the steam between the rack and the tray;
a circulation duct that includes inside a circulation fan so as to circulate gas in the heating chamber;
a convection heater that is disposed in the circulation duct;
an air supply port through which outside air is taken into the heating chamber and that is disposed below a level of the tray;
an air discharge port through which gas in the heating chamber is discharged to the atmosphere and that is disposed below the level of the tray; and
a magnetron that supplies microwaves to the heating chamber and is deactivated based on a state of exhaust air at the air discharge port,
wherein
the cooking device is operated in:
a microwave mode in which cooking using microwaves is performed;
a grill mode in which the circulation fan and the convection heater are driven so that cooking using superheated steam is performed; and
a steaming mode in which the circulation fan and the convection heater are deactivated so that cooking using saturated steam is performed.

2. The cooking device according to claim 1, wherein
the air supply port is disposed below a level of the air discharge port.

3. The cooking device according to claim 1, wherein
the air supply port is disposed at a front portion of the heating chamber, and the air discharge port is disposed at a back portion of the heating chamber.

4. The cooking device according to claim 2, wherein
the air supply port is disposed at a front portion of the heating chamber, and the air discharge port is disposed at a back portion of the heating chamber.
